(19) United States
(12) Patent Application Publication
(10) Pub. No.: US 2007/0281634 A1
(43) Pub. Date: Dec. 6, 2007

(54) Method and device for wireless communications on multiple frequency bands

(76) Inventors: Surya Prashant Rao, Bangalore (IN); Darpan Majumder, Uttarpara (IN)

Correspondence Address: FAY KAPLUN & MARCIN, LLP, 15O BROADWAY, SUITE 702, NEW YORK, NY, 10038, US

(21) Appl. No.: 11/447,578

(22) Filed: Jun. 6, 2006

(51) Int. Cl. H04B 1/04; H04B 7/00; H04B 1/38

(52) U.S. Cl. 455/103; 455/507; 455/561

(57) ABSTRACT

Described is a method and device for wireless communications on multiple frequency bands. The device comprises a communications arrangement and a processor. The communications arrangement receives radio frequency (RF) maps from a plurality of wireless communication devices. The RF maps are indicative of wireless activity in respective environments of the plurality of wireless devices. The processor generates a frequency band hopping sequence as a function of the RF maps. The frequency band hopping sequence is transmitted to the plurality of devices.

### FIELD OF THE INVENTION

The present invention relates generally to methods and devices for wireless communications on multiple frequency bands.

### BACKGROUND

In a conventional wireless network, wireless devices, e.g., access points (APs) and mobile units (MUs), use either a 2.4 GHz frequency band or a 5.1 GHz frequency band for wireless communications based on a wireless protocol used thereby. For example, the devices using an 802.11b/g protocol communicate on the 2.4 GHz frequency band, and the devices using an 802.11a protocol communicate on the 5.1 GHz frequency band. It is increasingly common for the devices to utilize radio frequency chipsets which support a plurality of 802.11 protocols, e.g., 802.11a/b/g, for cross- and backward compatibility with other devices in the wireless network. For example, the AP may utilize such a chipset to communicate with a first MU configured for the 802.11g protocol and a second MU configured for the 802.11a protocol. The chipsets may also be used in the MUs in a similar manner. However, the chipsets are configured to support only one protocol at a time, limiting potential use of the other protocols (and frequency bands).

### SUMMARY OF THE INVENTION

The present invention relates to a method and device for wireless communications on multiple frequency bands. The device comprises a communications arrangement and a processor. The communications arrangement receives radio frequency (RF) maps from a plurality of wireless communication devices. The RF maps are indicative of wireless activity in respective environments of the plurality of wireless devices. The processor generates a frequency band hopping sequence as a function of the RF maps. The frequency band hopping sequence is transmitted to the plurality of devices.

### DESCRIPTION OF THE DRAWINGS

FIG. 1 shows an exemplary embodiment of a system for wireless communications on multiple frequency bands according to the present invention.

FIG. 2 shows an exemplary embodiment of a method for wireless communications on multiple frequency bands according to the present invention.

FIG. 3 shows an exemplary embodiment of a band-hopping sequence for wireless communications on multiple frequency bands according to the present invention.

### DETAILED DESCRIPTION

The present invention may be further understood with reference to the following description and the appended drawings, wherein like elements are referred to with the same reference numerals. The present invention describes a method and device for wireless communications on multiple frequency bands. While the exemplary embodiments of the present invention will be described with reference to two frequency bands (e.g., a 2.4 GHz band and a 5.1 GHz band), those of skill in the art will understand that the present invention may be utilized on any frequency bands provided for wireless communications.

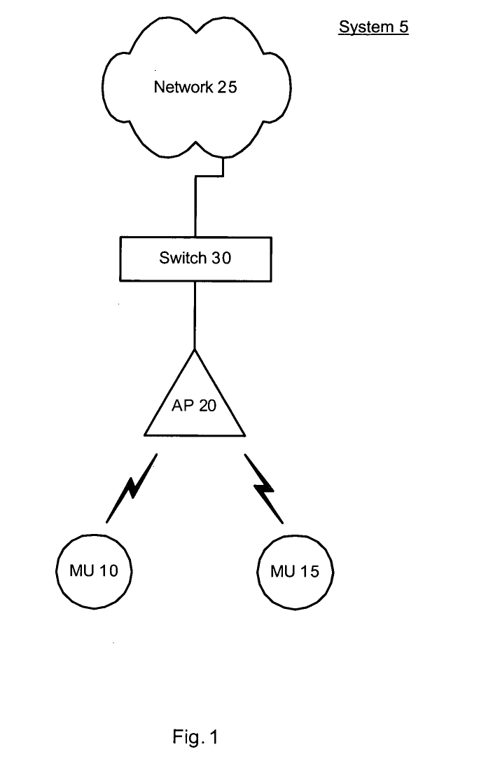

FIG. 1 shows an exemplary embodiment of a system 5 according to the present invention. In the system 5, mobile units (MUs) 10, 15 conduct wireless communications with an access point/port (AP) 20. The AP 20 is provided access to a communications network 25 (e.g., the Internet, an intranet, LAN/WAN, etc.) via a network management arrangement (e.g., a switch 30). In the exemplary embodiment, the AP 20 is coupled to the switch 30 via a wired connection. However, those of skill in the art will understand that the switch 30 may be a wireless switch that communicates with the AP 20 on a radio frequency channel or is integral with the AP 20. The MUs 10, 15 may be any wireless communication devices including, but not limited to, imager-/laser-based scanners, RFID readers/tags, mobile phones, PDAs, tablets, network interface cards, portable media players, cameras, etc.

Each of the MUs 10, 15 and the AP 20 includes a radio frequency (RF) chipset supporting wireless communications according to, at least, a first protocol (e.g., 802.11a) and a second protocol (e.g., 802.11g). That is, those of skill in the art will understand that the RF chipset may support multiple protocols and is not limited to the first and second protocols. For example, the RF chipset may support a third protocol (e.g., 802.11b), or the third protocol may be interchangeable with the second protocol because they utilize the same frequency band. As is known in the art, the protocols used by the MUs 10, 15 and the AP 20 dictate corresponding frequency bands used for transmitting and receiving wireless signals. That is, the 802.11a protocol utilizes a 5.1 GHz frequency band, and the 802.11g protocol uses a 2.4 GHz frequency band. In the exemplary embodiments, the AP 20 utilizes a predetermined number of radio transceivers to communicate on the different frequency bands. For example, a first transceiver may be used to communicate on the 5.1 GHz band and a second transceiver may be used to communicate on the 2.4 GHz band. The MUs 10, 15 may each utilize a single radio transceiver, but support communications on any of the frequency bands using the RF chipset.

In the exemplary embodiment, the switch 30 gathers data (e.g., RF maps) from the MUs 10, 15 and the AP 20 indicative of activity in their respective wireless environments (“local wireless environments”). The switch 30 uses the data to construct an RF map of a system wireless environment which includes the AP 20, the MUs 10, 15 and any other wireless devices associated with the AP 20. The RF map allows the switch 30 to analyze activity on the frequency bands within the system 5. Based on the analysis of the activity on the frequency bands, the switch 30 instructs each of the MUs 10, 15 and the AP 20 to implement a band-hopping sequence, allowing the MUs 10, 15 to communicate with the AP 20 simultaneously on different frequency bands, as will be explained further below. As understood by those of skill in the art, simultaneous communication between the AP 30 and the MUs 10, 15 may reduce use of medium contention mechanisms (e.g., CSMA/CA), increasing throughput in the system 5.

As is known in the art, the CSMA/CA media access mechanism describes use of a back-off timer by wireless devices attempting to gain access to, for example, a radio frequency channel. In the exemplary embodiments of the present invention, the chipset in an MU (e.g., the MU 10), after determining that the first frequency band is busy, may set the back-off timer to a predetermined inter-frame spacing (e.g., a DIFS). Before expiration of the DIFS, the second frequency band may be free, and the chipset transmits packets to the AP 30 on the second frequency band.

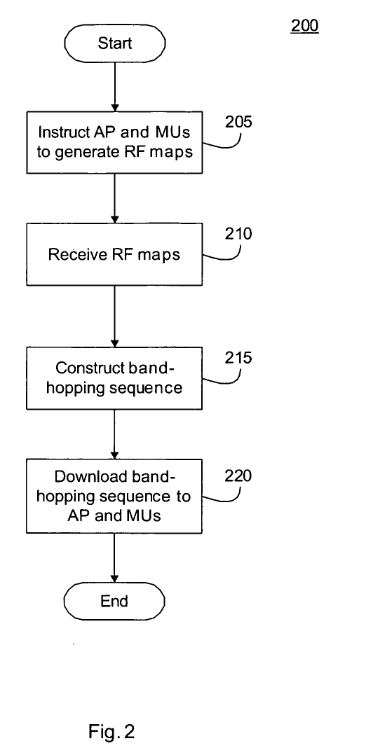

FIG. 2 shows an exemplary embodiment of a method 200 for wireless communication on multiple frequency bands according to the present invention. In step 205, the switch 30 instructs the AP 20 and the MUs 10, 15 to generate RF maps of their respective local wireless environments. While the exemplary embodiment describes the AP 20 and the MUs 10, 15 generating the RF maps, those of skill in the art will understand that the switch 30 may selectively transmit the instruction to generate the RF maps to one or more of the wireless devices coupled thereto. For example, the switch 30 may instruct the AP 20 to generate its RF map, and the AP 20 may forward the instruction to all wireless devices associated with the AP 20.

In the exemplary embodiment, the AP 20 may generate the RF map by operating the RF chipset in a scan mode in which the RF chipset is tuned through a plurality of RF channels in each of the frequency bands in a predetermined sequence. The AP 20 detects (and measures) wireless activity on each RF channel to generate the RF map in the local wireless environment. As known in the art, the activity (e.g., 802.11x signals) on each of the RF channels may be measured in terms of received signal strength (RSSI) values. In another exemplary embodiment, the RF chipset may be configured to analyze activity on an entire frequency band at a single time. The RF chipset may take in the entire frequency band and utilize a signal processing technique (e.g., a Fast Fourier Transform) to analyze activity on the entire frequency band with predefined portions of the entire frequency band corresponding to each of the RF channels. Those of skill in the art will understand that the MUs 10, 15 may utilize similar methods for generating their respective RF maps.

In step 210, the switch 30 receives the RF maps from the AP 20 and the MUs 10, 15. In step 215, the switch 30 constructs a band-hopping sequence based on the RF maps or selected ones thereof. In the exemplary embodiment, the band-hopping sequence includes frequency band instructions indicating which of the frequency bands should be used to conduct wireless communications between the AP 20 and the MUs 10, 15 at corresponding time periods. That is, by instructing the MUs 10, 15 to utilize different frequency bands at different time periods, the MUs 10, 15 may communicate with the AP 20 simultaneously.

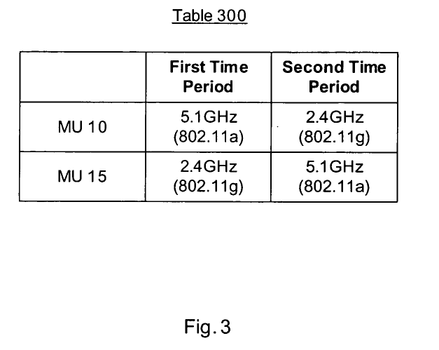

The band-hopping sequence may be embodied in any data structure and include data as shown in a table 300 in FIG. 3. For a first time period, the MU 10 communicates with the AP 20 on the 5.1 GHz band (using the 802.11a protocol) and the MU 15 communicates with the AP 20 on the 2.4 GHz band (using the 802.11g protocol). The AP 20 is capable of supporting simultaneous communications with the MUs 10, 15, because the RF chipset supports both protocols. In a second time period, the MU 10 utilizes the 2.4 GHz band and the MU 15 utilizes the 5.1 GHz band to communicate with the AP 20. As understood by those of skill in the art, when the AP 20 does not have any packets to transmit to the MU and the MU does not have any packets to transmit to the AP 20, the frequency band may be free. However, when either the AP 20 or the MU has packets to transmit, it uses the frequency band (and protocol) specified in the band-hopping sequence provided by the switch 30.

It should be noted that when generating the band-hopping sequence, the switch 30 needs to know the capability of each device. For example, if the MU 10 includes a chipset that does not provide 802.11(a) capabilities, the switch 30 should not provide a band-hopping sequence indicating that the MU 10 should hop to 802.11(a) frequencies. Those skilled in the art will understand that the switch 30 may obtain the information on the capabilities of individual devices (e.g., MUs and APs) in a number of manners. For example, the information may be included on the switch 30 as a part of the system 5 set-up (e.g., when an MU/AP is introduced into the system 5). Or, the information may be communicated by the device to the switch 30 when the device initiates wireless communications with the switch 30 (e.g., during association and authentication of the MU). In another example, the information may be included on a network server (e.g., an enterprise management server) or database that switch 30 may access to retrieve the information. The switch 30 may look-up or retrieve the information based on the BSSID (described below) or other unique identifier for the device.

In step 220, the switch 30 downloads the band-hopping sequence to the AP 20 and the MUs 10, 15. The band-hopping sequence may be transmitted from the AP 20 to the MUs 10, 15 in a beacon frame (e.g., a hybrid beacon frame containing media access information for all (or selected ones of) the frequency bands). In use, during the first time period, the AP 20 may receive packets from the MUs, 10, 15 simultaneously, because they are transmitting on different frequency bands. The AP 20 may support simultaneous transmissions from the MUs 10, 15 by using the RF chipset described above. Alternatively, the AP 20 may receive packets from one MU (e.g., the MU 10) and transmit packets to a further MU (e.g., the MU 15) simultaneously. For example, if the MU 15 does not have any packets to upload to the AP 20, the AP 20 may download packets to the MU 15 during the first time period on the 2.4 GHz band, and receive packets form the MU 10 on the 5.1 GHz band.

After the first time period expires, the MUs 10, 15 may re-tune their respective RF chipsets in accordance with the table 300. That is, at an onset of the second time period, the MU 10 may terminate transmissions on the 5.1 GHz band and utilize the 2.4 GHz band, and vice-versa for the MU 15. By following the band-hopping sequence provided in the table 300, the MUs 10, 15 may receive data packets on different frequency bands during a sequence of the time periods and reconstruct the data. As stated above, a plurality of the MUs may communicate with the AP 20 during each time period with each MU transmitting/receiving on a unique frequency band.

As understood by those of skill in the art, the radio transceivers utilized for communication according to the 802.11a and the 802.11g protocols, respectively, may use a same basic service set identifier (BSSID). Thus, the AP 20 and the MUs 10,15 are capable of identifying received packets on the frequency bands.

As understood by those of skill in the art, the exemplary embodiments of the present invention increases throughput by at least two-fold relative to conventional wireless networks. For example, in the conventional network, the AP and the MUs within a WLAN will contend for access to an RF channel. Thus, if the MU 10 gained access to the RF channel, the MU 15 would be required to wait until the RF channel was clear before attempting to transmit, execute a power-save poll, etc. By setting a schedule for the MUs 10, 15 to communicate with the AP 20, contention for each channel is divided by at least two. That is, further MUs may be contending for the same RF channels at the same time as the MUs 10, 15. However, by using the RF maps from devices associated with the AP 20, the switch 30 may generate the band-hopping sequence to, for example, put half the devices on the 2.4 GHz band and the other half of the device on the 5.1 GHz during the first time period, reducing contention for each of the frequency bands by two. Thus, the present invention may increase data transfer rates between wireless devices, providing better quality-of-service for voice and video applications.

In addition, distributed applications may be processed faster at run time locations based on network connectivity. For example, an employer may receive an order for a piece of equipment on a wireless device. The employer uses the wireless device to access a component list for the piece of equipment stored in a (remote) backend database. The employer downloads the component list from the wireless device to a plurality of further wireless devices used by employees in a warehouse who, upon receiving the component list, transmit status responses regarding status of the components. Based on the status responses, the employer may compute a time for all of the components on the component list to reach an assembly location and estimate a manufacture time based thereon.

In an alternative exemplary embodiment of the present invention, the system 5 executes half-duplex communication. The switch 30 may select the first frequency band (e.g., 2.4 GHz) for receiving functionality and the second frequency band (e.g., 5.1 GHz) for transmitting functionality, and download instruction data to the MUs 10, 15 and the AP 20 regarding the selections. Thus, the MUs 10, 15 and the AP 20 use the instruction data when transmitting and receiving packets.

Those of skill in the art will understand that other network infrastructure devices such as, for example, routers, hubs, APs, bridges, etc. may perform the functions of the switch 30 described herein.

From the above description and the appended drawings, those of skill in the art will understand that the exemplary embodiments of the present invention may provide MIMO functionality, i.e., virtual MIMO, for the APs and the MUs in the system. That is, the exemplary embodiments describe a TDMA-based MIMO mechanism for wireless devices with only one or two transceivers. However, the present invention may also be implemented on conventional MIMO devices to increase bandwidth.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a communications arrangement receiving radio frequency (RF) maps from a plurality of wireless communication devices, the RF maps indicative of wireless activity in respective environments of the plurality of wireless devices; and
a processor generating a frequency band hopping sequence as a function of the RF maps and transmitting the frequency band hopping sequence to the plurality of devices.

2. The device according to claim 1, wherein the device is one of a switch, an access point, a router, a hub and a bridge.

3. The device according to claim 1, wherein the frequency band hopping sequence instructs a first set of the plurality of devices to communicate with an access point on a first frequency band during a first time period and instructs a second set of the plurality of devices to communicate with the access point on a second frequency band during the first time period.

4. The device according to claim 3, wherein the first frequency band is a 2.4 GHz band and the second frequency band is a 5.1 GHz band.

5. The device according to claim 3, wherein the first set and the second set include mobile communication units which include at least one of image-based scanners, laser-based scanners, RFID readers, PDAs, mobile phones, network interface cards, laptops and tablets.

6. The device according to claim 5, wherein the frequency band hopping sequence is transmitted from the device to the access point and the access point transmits the band hopping sequence to the mobile communication units in a beacon frame.

7. The device according to claim 1, wherein the plurality of devices generate the RF maps by scanning through a plurality of radio frequency channels and detecting wireless activity on each of the radio frequency channels.

8. The device according to claim 3, wherein the access point utilizes a first transceiver to communicate on the first frequency band and a second transceiver to communicate on the second frequency band.

9. The device according to claim 8, wherein the first and second transceivers utilize a single basic service set identifier.

10. The device according to claim 3, wherein the first frequency band supports a first wireless communication protocol and the second frequency band supports a second wireless communication protocol.

11. The device according to claim 10, wherein the first wireless communication protocol is an 802.11a protocol and the second wireless communication protocol is one of an 802.11b protocol and an 802.11g protocol.

12. The device according to claim 3, wherein each of the first and second mobile units includes a radio transceiver for alternately communicating on the first and second frequency bands.

13. The device according to claim 12, wherein the radio transceiver supports a plurality of wireless communication protocols.

14. A device, comprising:
a first transceiver communicating on a first radio frequency band;
a second transceiver communicating on a second radio frequency band; and
a processor receiving an instruction to generate a radio frequency (RF) map indicative of wireless activity in a surrounding environment, the processor scanning the first and second transceivers through a plurality of radio frequency channels to detect wireless activity on each of the channels for each of the first and second radio frequency bands, the processor generating the RF map as a function of the detected wireless activity and transmitting the RF map to a network management arrangement.

15. The device according to claim 14, wherein, after transmitting the RF map to the network management arrangement, the device receives a frequency band hopping sequence from the network management arrangement and operates the first and second transceivers as a function thereof, the frequency band hopping sequence instructing the device to communicate with a first set of mobile communication units on the first frequency band during a first time period and a second set of mobile communication units on the second frequency band during the first time period.

16. The device according to claim 14, wherein the first frequency band is a 2.4 GHz band and the second frequency band is a 5.1 GHZ band.

17. The device according to claim 14, wherein the device is an access point.

18. The device according to claim 15, wherein the device transmits the frequency band hopping sequence to the first and second sets of mobile communication units in at least one beacon frame.

19. A method, comprising:
receiving radio frequency (RF) maps from a plurality of wireless communication devices, the RF maps indicative of wireless activity in respective environments of the plurality of wireless devices;
generating a frequency band hopping sequence as a function of the RF maps; and
transmitting the frequency band hopping sequence to the plurality of devices.

20. The method according to claim 19, further comprising:
obtaining wireless communication capability information about each of the plurality of devices; and
adjusting the frequency band hopping sequence as a function of the information.

21. The method according to claim 19, wherein the information is indicative of at least one wireless communication protocol supported by a corresponding device.

22. The method according to claim 19, wherein the plurality of devices include at least one access point and a plurality of mobile communication units.

23. A device, comprising:
a receiving means for receiving radio frequency (RF) maps from a plurality of wireless communication devices, the RF maps indicative of wireless activity in respective environments of the plurality of wireless devices;
a processing means for generating a frequency band hopping sequence as a function of the RF maps; and
a transmitting means for transmitting the frequency band hopping sequence to the plurality of devices.
